(19) United States
(12) Patent Application Publication
(10) Pub. No.: US 2019/0156054 A1
(43) Pub. Date: May 23, 2019

(54) DATA LOSS PREVENTION SYSTEM AND METHOD IMPLEMENTED ON CLOUD

(71) Applicant: SOMANSA CO., LTD., Seoul (KR)

(72) Inventors: Hwan Cheol LIM, Incheon (KR); Il Hoon CHOI, Seoul (KR)

(73) Assignee: SOMANSA CO., LTD.

(21) Appl. No.: 15/824,229

(22) Filed: Nov. 28, 2017

(30) Foreign Application Priority Data
Nov. 23, 2017 (KR) 10-2017-0157319

(51) Int. Cl. G06F 21/62; H04L 29/06; H04L 29/12; H04L 12/46

(52) U.S. Cl. CPC G06F 21/6245; H04L 63/029; H04L 63/20; H04L 61/2592; H04L 61/6059; H04L 12/4633; H04L 61/305; H04L 63/0245; H04L 61/251

(57) ABSTRACT

Provided is a data loss prevention system implemented on cloud. The system includes: an address converter for receiving traffic from a private network using tunneling and converting a private IP address of the received traffic to a IPv6 address, which is unique in the data loss prevention system; and a data loss prevention unit for analyzing the traffic, in which the private IP address is converted to the IPv6 address, according to a predetermined policy and examining whether personal information or confidential information is included.

### CROSS-REFERENCE TO RELATED PATENT APPLICATION

This application claims the benefit of Korean Patent Application No. 10-2017-0157319, filed on Nov. 23 2017, in the Korean Intellectual Property Office, the disclosure of which is incorporated herein in its entirety by reference.

### FIELD

The present invention relates to a data loss prevention system and a method of preventing personal information or confidential information from leaking and more particularly, to a data loss prevention system and a method implemented on cloud.

### BACKGROUND

A data loss prevention system analyzes traffic of e-mails, messengers, and SNSs transmitted from the inside of companies or organizations to the outside and blocks the transmission if critical information such as personal information or confidential information is included, thereby preventing information leakage to the outside.

In general, a user (for example, companies or organizations) of the data loss prevention system (for example, companies or organizations) purchases a hardware form product and the data loss prevention system is provided by installing the purchased product to the user's network. However, although a current increase of the need, it was hard to introduce a personal data loss prevention system except for a large-scaled user who may afford the expense.

Therefore, in order to provide a data loss prevention system at a low cost, data loss prevention service in a Security As A Service (SECaaS) form, which uses a cloud environment, is introduced. Such a cloud-based data loss prevention service is useful in terms of costs, management, and easy distribution.

However, companies or organizations mostly use a private network and thereby, if private address band owned by each user's private network is overlapped with each other, a service provider hardly recognizes a user of a terminal which transmits traffic. Accordingly, in order to provide the cloud-based data loss prevention service, a service provider may separately establish a data loss prevention system for each user on cloud. Therefore, the cloud-based data loss prevention service is not still activated due to limitations of costs.

### SUMMARY

The present invention provides a data loss prevention system and a method of providing data loss prevention service to many users by using a single system after traffic transmitted from a private network of many users is recognized by individual user, although private address bands owned by each user's private network are overlapped with each other.

According to an aspect of the present invention, there is provided a data loss prevention system implemented on cloud including an address converter for receiving traffic from a private network using tunneling and converting a private IP address of the received traffic to a IPv6 address, which is unique in the data loss prevention system; and a data loss prevention unit for analyzing the traffic, in which the private IP address is converted to the IPv6 address, according to a predetermined policy and examining whether personal information or confidential information is included.

When the private IP address is a IPv4 address, the address converter may convert the IPv4 address to a IPv6 address and includes a unique identifier that corresponds to the private network in the converted IPv6 address.

The unique identifier may be included in prefix of an IPv6 address space.

The prefix may correspond to upper 48 bit of the IPv6 address space.

When the private IP address is a IPv6 address, the address converter may include a unique identifier that corresponds to the private network in the IPv6 address.

The unique identifier may be included in prefix of an IPv6 address space.

According to another aspect of the present invention, there is provided a data loss prevention method performed in a data loss prevention system implemented on cloud including: receiving traffic from a private network using tunneling; converting a private IP address of the received traffic to a IPv6 address, which is unique in the data loss prevention system; and analyzing the traffic, in which the private IP address is converted to the IPv6 address, according to a predetermined policy and examining whether personal information or confidential information is included.

When the private IP address is a IPv4 address, the converting may comprise converting the IPv4 address to a IPv6 address; and including a unique identifier that corresponds to the private network in the converted IPv6 address.

When the private IP address is a IPv6 address, the converting may comprise including a unique identifier that corresponds to the private network in the IPv6 address.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a data loss prevention system according to an embodiment of the present invention;

FIG. 2 is a flowchart illustrating a data loss prevention method according to an embodiment of the present invention;

FIG. 3A illustrates an example of a process in which an IPv4 address of a first private network is converted to a unique IPv6 address in the system;

FIG. 3B illustrates an example of a process in which an IPv4 address of a second private network is converted to a unique IPv6 address in the system; and

FIG. 3C illustrates an example of a process in which an IPv6 address of a third private network is converted to a unique IPv6 address in the system.

### DETAILED DESCRIPTION

Hereinafter, the present invention will be described more fully with reference to the accompanying drawings, in which exemplary embodiments of the invention are shown. Like reference numerals in the description below and drawings denote like elements. In the description, the detailed descriptions of well-known technologies and structures may be omitted so as not to hinder the understanding of the present invention.

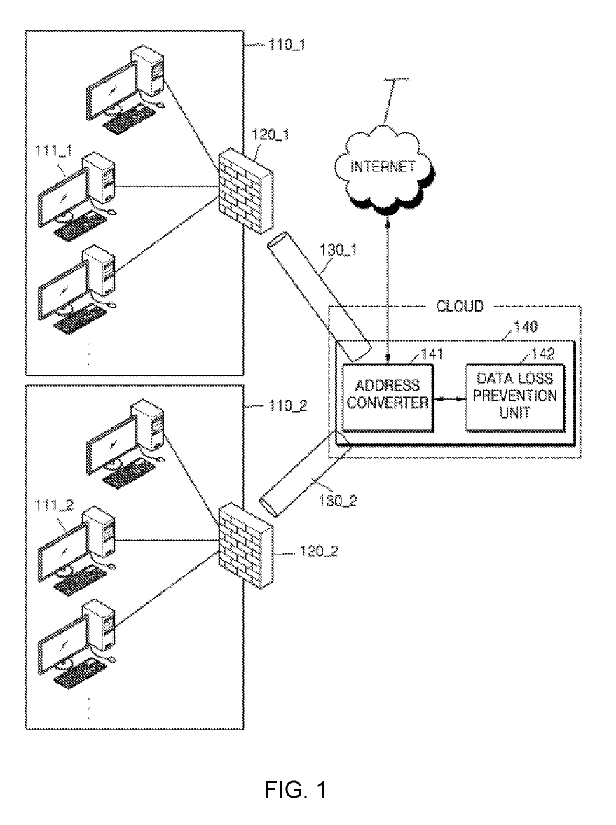

FIG. 1 illustrates a data loss prevention system 140 according to an embodiment of the present invention.

The data loss prevention system 140 is implemented on cloud and is connected to each private network used by a plurality of users through IP tunnels. For example, as illustrated in the drawing, the data loss prevention system 140 is connected to a first firewall 120_1 installed to a first private network 110_1 of a first user through a first IP tunnel 130_1 and is connected to a second firewall 120_2 installed to a second private network 110_2 of a second user through a second IP tunnel 130_2.

When traffic generates from an arbitrary first terminal 111_1 in the first private network 110_1 to the outside, the first firewall 120_1 transmits such traffic to the data loss prevention system 140 through the first IP tunnel 130_1 using a tunneling protocol (for example, GRE or IPsec).

In the same manner, when traffic generates from an arbitrary second terminal 111_2 in the second private network 110_2 to the outside, the second firewall 120_2 transmits such traffic to the data loss prevention system 140 through the second IP tunnel 130_2 using a tunneling protocol (for example, GRE or IPsec).

Hereinafter, a private network 110 denotes the first private network 110_1, the second private network 110_2, or another non-illustrated private network, and a terminal 111 denotes the first terminal 111_1, the second terminal 111_2, or another non-illustrated terminal in the other private network. This applies to a firewall 120 and an IP tunnel 130 in the same manner.

The data loss prevention system 140 includes an address converter 141 and a data loss prevention unit 142.

The address converter 141 receives traffic generated in the terminal 111 from the firewall 120 of the private network 110 through the IP tunnel 130 using a tunneling protocol.

In the embodiment of the present invention, in order for the data loss prevention unit 142 to recognize traffic transmitted from private networks of various users by each user, the address converter 141 converts a private IP address of the received traffic to a IPv6 address, which is unique in the data loss prevention system 140, and transmits traffic of the IPv6 address to the data loss prevention unit 142.

Then, the data loss prevention unit 142 aggregates traffic of the IPv6 address, which is unique in the data loss prevention system 140, reconfigures the aggregated traffic by each session, and decodes the traffic, if encoded. Next, the data loss prevention unit 142 analyzes the decoded traffic according to a predetermined policy (or a policy predetermined by each user) and examines whether personal information or confidential information is included.

If personal information or confidential information is included according to the analyzed result of the traffic, the data loss prevention unit 142 blocks such traffic from being transmitted to the outside and sends a block message informing that the traffic is blocked due to concern about information leakage to the terminal 111, which generates the traffic, and a network manager of a user, if needed.

Since the data loss prevention unit 142 receives the traffic including the converted address, which is unique in the data loss prevention system 140, the data loss prevention unit 142 may recognize where the terminal 111, which generates such traffic, is included from among the users, that is, the private networks, even if private address band owned by the private networks of each user is overlapped with each other. Accordingly, the data loss prevention unit 142 may analyze the traffic according to a policy set by each user and control the traffic by each user.

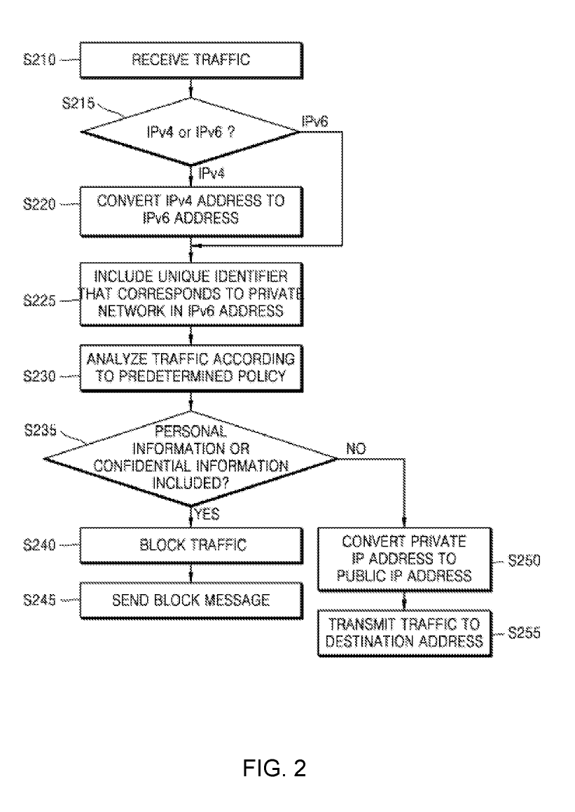

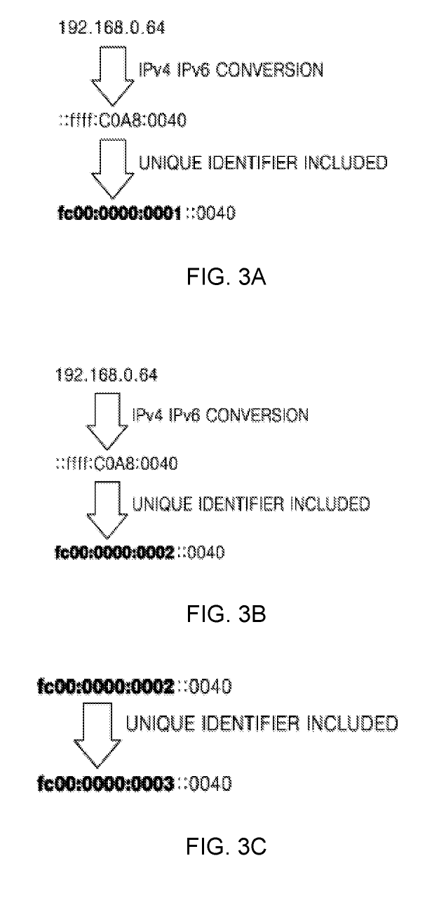

A process of converting a private IP address of the traffic to the IPv6 address, which is unique in the data loss prevention system 140, by the address converter 141 will be described in more detail with reference to FIGS. 2 through 3.

FIG. 2 is a flowchart illustrating a data loss prevention method according to an embodiment of the present invention.

In operation S210, the address converter 141 receives the traffic generated by the terminal 111 in the private network 110 through the IP tunnel 130 using tunneling.

Next operations S215 through S225 illustrate that a private IP address of the traffic is converted to the IPv6 address, which is unique in the data loss prevention system 140.

According to an IPv6 address system, upper 48 bit or more may be used as prefix from among an address space of 128 bit. Thus, a range, which may be used as an internal address, is 80 bit at the most and is enough, considering that current users mostly use an IPv4 address system.

Also, at a RFC 4193 standard, fc00::/7 band, that is, an address band, in which upper 7 bit has “1111110”, is determined as a unique local address and thus, may be used as a private IP band. Also, there is a possibility that fec0::/10 band that is not used in a RFC 3879 standard any longer may be used as a private IP band.

Accordingly, in the embodiment of the present invention, a unique identifier that corresponds to a user, that is, a private network, is included in prefix of upper 48 bit, in order to generate a unique address in the data loss prevention system 140. Thus, the private networks are classified and fc00::/7 band or fec0::/10 band is used as an address band. When fc00::/7 band is used, 41 bit, in which 7 bit is excepted from 48 bit, may be used as a domain for a unique identifier of a private network. When fec0::/10 band is used, 38 bit, in which 10 bit is excepted from 48 bit, may be used as a domain for a unique identifier of a private network. As such, when 41 bit or 38 bit is used as a domain for a unique identifier, the number of allocable unique identifiers is 2⁴¹ or 2³⁸ and such number is excessively larger than the practically acceptable number of users.

However, in the embodiment of the present invention, since upper 48 bit is used as prefix in the data loss prevention system 140, a range that may be used as an internal address is a maximum of 80 bit and thereby, a user of a IPv4 network does not have a difficulty (as IPv4 is only 32 bit). However, a user of an IPv6 network needs prefix of above 48 bit at the such private network (that is, an internal address of below 80 bit).

Referring back to FIG. 1, a unique identifier is respectively allocated to the first private network 110_1 of the first user and the second private network 110_2 of the second user. The data loss prevention system 140 owns unique identifier information of each private network and, when the traffic is received, recognizes from which private network 110 the traffic is received according to the tunnel 130 that transmits the traffic.

Referring back to FIG. 2, in operation S215, the address converter 141 identifies whether a private IP address of the received traffic is a IPv4 address or a IPv6 address.

When in the IPv4 address, the address converter 141 converts the IPv4 address of the traffic to the IPv6 address, in operation S220. Here, such a conversion may be realized according to a predefined address conversion system. For example, in a typical address conversion system, first 80 bit of the IPv6 address is set to 0, next 16 bit is set to 1, and then the IPv4 address is recorded to the remaining 32 bit.

Next, in operation S225, the address converter 141 includes a unique identifier that corresponds to a private network, which transmits the traffic, in the converted IPv6 address. As described above, the unique identifier may be included in prefix that corresponds to upper 48 bit of a IPv6 address space.

For example, when a unique identifier of the first private network 110_1 is ‘1’ and a private address band is 192.168.0.0/24 (that is, 192.168.0.0-192.168.0.255), 192.168.0.0/24 band is converted to ::ffff:C0A8:0000/120 band (that is, ::ffff:C0A8:0000˜::ffff:C0A8:00ff), in operation S220. In operation S225, when the unique identifier 1 of the first private network 110_1 is included in prefix of upper 48 bit, ::ffff:C0A8:0000/120 band is converted to fc00:0000:0001::/120 band. Here, “ffff” appeared by IPv4 IPv6 conversion and “C0A8:00” that corresponds to “192.168.0”, which is upper 24 bit of 192.168.0.0/24 band are all substituted with 0 due to meaninglessness for classifying an address. Both parts may be substituted with an arbitrary value or may leave without change.

For example, when a unique identifier of the second private network 110_2 is ‘2’ and a private address band is 192.168.0.0/24, which is same as in the first private network 110_1, 192.168.0.0/24 band is converted to ::ffff:C0A8:0000/120 band (that is, ::ffff:C0A8:0000 ::ffff:C0A8:00ff), as in the first private network 110_1, in operation S220. In operation S225, when the unique identifier 2 of the second private network 110_2 is included in prefix of upper 48 bit, ::ffff:C0A8:0000/120 band is converted to fc00:0000:0002::/120 band.

As described above, the private address band of the first private network 110_1 and the second private network 110_2 is 192.168.0.0/24, which is the same. However, since a unique identifier of each private network is included in the converted IPv6 address, the address bands of the first private network 110_1 and the second private network 110_2 in the data loss prevention system 140 are respectively fc00:0000:0001::/120 and fc00:0000:0002::/120, which are different from each other, and thus, may not conflict with each other.

FIGS. 3A and 3B respectively illustrate examples of a process in which the same IPv4 address of the first private network 110_1 and the second private network 110_2 is converted to a unique IPv6 address in the data loss prevention system 140. FIGS. 3A and 3B illustrate that the private IP address of the first terminal 111_1 of FIG. 1 in the first private network 110_1 and the private IP address of second terminal 111_2 of FIG. 1 in the second private network 110_2 are all 192.168.0.64

Referring to FIG. 3A, ‘192.168.0.64’, which is the IPv4 address, is converted to ‘::ffff:C0A8:0040’, which is the IPv6 address, through IPv4 IPv6 conversion, in operation S220. Then, “ffff:C0A8:00” in ‘::ffff:C0A8:0040’ is all substituted with 0 and prefix “fc00:0000:0001” including the unique identifier ‘1’ of the first private network 110_1 is combined therewith. Therefore, the IPv6 address is converted to ‘fc00:0000:0001::0040’, in operation S225.

Referring to FIG. 3B, ‘192.168.0.64’, which is the IPv4 address, is converted to ‘::ffff:C0A8:0040’, which is the IPv6 address, through IPv4 IPv6 conversion, in operation S220. Then, “ffff:C0A8:00” in ‘::ffff:C0A8:0040’ is all substituted with 0 and prefix “fc00:0000:0002” including the unique identifier ‘2’ of the second private network 110_2 is combined therewith. Therefore, the IPv6 address is converted to ‘fc00:0000:0002::0040’, in operation S225.

As such, since the private IP addresses of the first terminal 111_1 in the first private network 110_1 and the second terminal 111_2 in the second private network 110_2 are both 192.168.0.0/24, a unique identifier of each private network is included in the converted IPv6 address and thereby, the addresses in the data loss prevention system 140 are respectively ‘fc00:0000:0001::0040’ and ‘fc00:0000:0002::0040’, which are different from each other. Therefore, the addresses may not conflict with each other

Referring back to FIG. 2, when it is identified that the private IP address of the received traffic is the IPv6, in operation S215, operation S225 is performed so that the address converter 141 includes a unique identifier that corresponds to the private network, which transmits such traffic, in the IPv6 address of such traffic. Also, in this case, the unique identifier may be included in prefix that corresponds to upper 48 bit of a IPv6 address space.

For example, when a unique identifier of a third private network (not illustrated), which uses an IPv6 address, is ‘3’ and a private address band is fc00:0000:0002::/48, it seems that such private address band is overlapped with fc00:0000:0002::/120, which a converted band of the second private network 110_2 in the data loss prevention system 140. However, in the embodiment of the present invention, since the unique identifier 3 of the third private network is included in prefix, fc00:0000:0002::/48 band is converted to fc00:0000:0003::/48 band and thus, the band of the third private network is not overlapped with fc00:0000:0002::/120.

FIG. 3C illustrates an example of a process in which an IPv6 address of the third private network is converted to a unique IPv6 address in the data loss prevention system 140. FIG. 3C illustrates that a private IP address of a certain terminal in the third private network is fc00:0000:0002::0040.

Referring to FIG. 3C, ‘fc00:0000:0002::0040’, which is the private IPv6 address, is converted to ‘fc00:0000:0003::0040’ after prefix “fc00:0000:0003” including the unique identifier ‘3’ of the third private network, instead of prefix “fc00:0000:0002” in the second private network, is combined with the internal address “::0040”.

As such, the private IPv6 address of the third private network, ‘fc00:0000:0002::0040’, is the same as the converted address of the second private network 110_2, ‘fc00:0000:0002::0040’, and thus, it seems that a conflict occurs. However, ‘fc00:0000:0002::0040’, which is the private IPv6 address of the third private network, is converted to ‘fc00:0000:0003::0040’ including the unique identifier of the third private network in the data loss prevention system 140 and thus a conflict does not occur.

Referring back to FIG. 2, in operation S230, the data loss prevention unit 142 analyzes the traffic including the address converted to IPv6 address, which is unique in the data loss prevention system 140, according to a predetermined policy.

In operation S235, when it is determined that personal information or confidential information is included in the traffic according to the analyzed result, the data loss prevention unit 142 blocks the traffic from be transmitted to the outside, in operation S240 and sends a block message informing that the traffic is blocked due to concern about information leakage to the terminal 111, which generates the traffic, and a network manager of a user, if needed, in operation S245.

In operation S235, when it is determined that personal information or confidential information is not included in the traffic according to the analyzed result, the address converter 141 converts the private IP address of the traffic to a public IP address, in operation S250, and transmits the traffic including the converted public IP address to a destination address.

According to the present invention, a private IP address of the received traffic is converted to a unique IPv6 address in the data loss prevention system. Thus, although private address bands owned by private networks of each user are overlapped with each other, traffic transmitted from private networks of various users may be recognized by individual user and thus, data loss prevention service may be provided to many users by using a single system.

Therefore, costs used by a service provider to establish and operate the data loss prevention system on cloud may be reduced and accordingly, small and medium scale user may use data loss prevention service with a low cost.

The device described herein may comprise a processor, a memory for storing program data and executing it, a permanent storage such as a disk drive, a communications port for handling communications with external devices, and user interface devices, including a touch panel, keys, buttons, etc. When software modules or algorithms are involved, these software modules may be stored as program instructions or computer readable codes executable on the processor on a computer-readable medium. Examples of the computer readable recording medium include magnetic storage media (e.g., ROM, floppy disks, hard disks, etc.), and optical recording media (e.g., CD-ROMs, or DVDs). The computer readable recording medium can also be distributed over network coupled computer systems so that the computer readable code is stored and executed in a distributed fashion. This media can be read by the computer, stored in the memory, and executed by the processor.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like. The words “mechanism”, “element”, “means”, and “configuration” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A data loss prevention system implemented on cloud, the system comprising:
an address converter for receiving traffic from a plurality of private networks to each of which a unique identifier is respectively allocated using tunneling and converting a private IP address of the received traffic to a IPv6 address, which is unique in the data loss prevention system; and
a data loss prevention unit for analyzing the traffic, in which the private IP address is converted to the IPv6 address, according to a predetermined policy and examining whether personal information or confidential information is included,
wherein when the private IP address is a IPv4 address, the address converter converts the IPv4 address to a IPv6 address and includes a unique identifier that is allocated to a private network which transmits the traffic in the converted IPv6 address so that the IPv6 address is unique in the data loss prevention system,
when the private IP address is a IPv6 address, the address converter includes a unique identifier that is allocated to a private network which transmits the traffic in the IPv6 address so that the IPv6 address is unique in the data loss prevention system, and
the data loss prevention unit recognize from which private network the traffic is received using the unique identifier included in the IPv6 address.

2. (canceled)

3. The system of claim 1, wherein the unique identifier is included in prefix of an IPv6 address space.

4. The system of claim 3, wherein the prefix corresponds to upper 48 bit of the IPv6 address space.

5. (canceled)

6. (canceled)

7. A data loss prevention method performed in a data loss prevention system implemented on cloud, the method comprising:
receiving traffic from a plurality of private networks to each of which a unique identifier is respectively allocated using tunneling;
converting a private IP address of the received traffic to a IPv6 address, which is unique in the data loss prevention system; and analyzing the traffic, in which the private IP address is converted to the IPv6 address, according to a predetermined policy and examining whether personal information or confidential information is included,
wherein the converting comprises:
when the private IP address is a IPv4 address, converting the IPv4 address to a IPv6 address and including a unique identifier that is allocated to a private network which transmits the traffic in the converted IPv6 address so that the IPv6 address is unique in the data loss prevention system; and
when the private IP address is a IPv6 address, including a unique identifier that is allocated to a private network which transmits the traffic in the IPv6 address so that the IPv6 address is unique in the data loss prevention system, and
wherein the analyzing comprises recognizing from which private network the traffic is received using the unique identifier included in the IPv6 address.

8. (canceled)

9. The method of claim 7, wherein the unique identifier is included in prefix of an IPv6 address space.

10. The method of claim 9, wherein the prefix corresponds to upper 48 bit of the IPv6 address space.

11. (canceled)

12. (canceled)
